(19) United States
(12) Patent Application Publication
(10) Pub. No.: US 2015/0145720 A1
(43) Pub. Date: May 28, 2015

(54) COARSE ATTITUDE DETERMINATION FROM GNSS ANTENNA GAIN PROFILING

(71) Applicant: AGCO Corporation, Duluth, GA (US)

(72) Inventor: Paul Matthews, Bel Aire, KS (US)

(73) Assignee: AGCO Corporation, Duluth, GA (US)

(21) Appl. No.: 14/369,855

(22) PCT Filed: Dec. 29, 2012
(86) PCT No.: PCT/US2012/072202

§ 371 Date: Jun. 30, 2014

Related U.S. Application Data
(60) Provisional application No. 61/581,869, filed on Dec. 30, 2011.

(51) Int. Cl. G01S 19/53

(52) U.S. Cl. CPC G01S 19/53
USPC 342/357.36

(57) ABSTRACT

Systems and methods provide coarse attitude determination without inertial sensor input. An attitude determination module can be configured to compare receiver-calculated values with expected values based on an antenna gain pattern. The differences between calculated and expected values can be used to generate an attitude plane. Platform attitude can be determined from the inclination of the attitude plane with respect to a horizontal reference plane. By way of example, platform roll and pitch can be determined for a receiver unit mounted on an agricultural vehicle. The roll and pitch values provided by the ADM can be used to improve the accuracy of receiver-calculated geo-positions.

### FIELD OF INVENTION

This invention relates generally to vehicle guidance systems, and more particularly to those employed on land vehicles.

### BACKGROUND OF INVENTION

Agricultural vehicles such as tractors, combines, and harvesters, as well as construction equipment, and various other off-road vehicles and equipment, are often equipped with guidance systems configured to assist an operator or enable autonomous operation. In the particular case of agricultural vehicles, a guidance system is often employed to ensure that the correct fields are worked, product is applied accurately, and crop is harvested thoroughly and efficiently. Most guidance systems include a positioning system for determining geographic location, and inertial sensors for determining vehicle attitude. For example, a positioning system can include a satellite receiver, such as a global positioning system (GPS) or global navigation satellite system (GNSS) receiver that can calculate geographical location using satellite navigation signal parameters. Typically, a GPS receiver provides a location based on an inherent assumption that a vehicle is traveling on a flat surface. However, a vehicle traversing sloped terrain may be oriented at an attitude that can be expressed in terms of yaw, pitch and/or roll. A vehicle's attitude can affect the accuracy of the calculated geo-position, thereby affecting guidance system performance.

Inertial sensors such as gyros and accelerators can be used to measure vehicle pitch, yaw and roll to improve the accuracy of a calculated geographical position. However, some guidance systems, particularly low end and legacy systems, lack inertial sensors; and, as a result, can be vulnerable to navigation and tracking inaccuracies that can impede performance and increase costs. There is a need to improve the performance of such guidance systems by determining or estimating a vehicle's attitude in the absence of onboard inertial sensors.

### SUMMARY OF THE INVENTION

Methods and systems that can provide coarse attitude determination without the use of inertial sensors are presented. Methods of the invention can be used to improve the accuracy of low end or legacy guidance systems, or to verify calculations performed by guidance systems equipped with inertial sensors. An example system can include a satellite receiver unit (SRU) configured to receive satellite navigation signals, and an attitude determination module (ADM) configured to determine the attitude of the satellite receiver unit, and thereby the attitude of platform on which the satellite unit is mounted. In an example embodiment, the ADM can provide roll and pitch angles for the satellite receiver unit. For example, a system can be mounted on a vehicle, such as an agricultural machine, and be configured to provide roll and pitch values when the vehicle is traversing sloped terrain. The roll and pitch values can be used to provide a more accurate geographical location for the vehicle. An example system of the invention can further include a position adjustment module configured to use the roll and pitch angles provided by the ADM to adjust a geographical position calculated by the SRU without consideration of platform attitude.

An example ADM can be configured to determine the attitude of a receiver platform, such as a land vehicle, without the use of onboard inertial sensors. In an example embodiment, an ADM can be configured to compare receiver-calculated values with antenna profile expected values. By way of example, but not limitation, an ADM can comprise a memory configured to store a gain profile for a satellite antenna of the SRU; a comparator submodule configured to compare receiver-based values associated with received satellite signals with expected values based on an antenna gain pattern; an attitude plane submodule configured to provide an attitude plane based on the comparisons; and an inclination submodule configured to determine the inclination of the attitude plane to provide roll and pitch angles for the SRU. In an exemplary embodiment, an ADM can further include an azimuth adjustment module configured to compensate for platform heading by revising receiver-based azimuth values when the satellite receiver unit is mounted on a platform having a heading other than due north.

In an example embodiment, a method can include determining the attitude of a platform without input from inertial sensors. An example method of the invention can comprise comparing receiver-based values with expected values, using the differences between the receiver-based and expected values to determine an attitude plane, and determining the inclination of the attitude plane with a reference plane. For example a method can include determining the difference between a satellite elevation angle calculated at an SRU receiver with an expected satellite elevation angle. As a further example, a method can include determining the difference between an effective gain of a received satellite signal with an expected gain. In an exemplary embodiment, expected values are based on the antenna gain pattern of the antenna associated with the receiver. In an exemplary embodiment, receiver-based values associated with signals from a plurality of satellites at a plurality of elevations are compared with expected values. By plotting the differences in three dimensions, an attitude plane can be generated. The inclination of the attitude plane with respect to a horizontal reference plane can be measured to provide pitch and roll values associated with the platform on which the satellite antenna is mounted. Thus, the attitude of an SRU and vehicle traversing sloped terrain can be determined even in the absence of onboard sensors. The pitch and roll values can be used to adjust a geographical position provided by a GPS receiver to provide a more accurate vehicle location for navigational purposes.

### BRIEF DESCRIPTION OF THE DRAWINGS

FIG. 1 shows an example system for coarse attitude determination.

FIG. 2 shows an example system for coarse attitude determination.

FIG. 3 shows an example system for attitude determination.

FIG. 4A shows an example method for attitude determination.

FIG. 4B shows an example method for attitude determination.

FIG. 4C shows an example method for attitude determination.

FIG. 5A shows an example plot of differences between calculated and expected values.

FIG. 5B shows an example attitude plane.

FIG. 5C shows an example plane rotated for azimuth adjustment

FIG. 6 shows an example system.

### DETAILED DESCRIPTION OF EXAMPLE EMBODIMENTS

As required, example embodiments of the present invention are disclosed. The various embodiments are meant to be non-limiting examples of various ways of implementing the invention and it will be understood that the invention may be embodied in alternative forms. The present invention will be described more fully hereinafter with reference to the accompanying drawings in which example embodiments are shown with like numerals representing like elements throughout. The figures are not necessarily drawn to scale and some features may be exaggerated or minimized to show details of particular elements, while related elements may be eliminated to prevent obscuring novel aspects. The specific structural and functional details disclosed herein should not be interpreted as limiting, but merely as a basis for the claims and as a representative basis for teaching one skilled in the art to variously employ the present invention. For example, while the exemplary embodiments are discussed in the context of an agricultural vehicle, it will be understood that the present invention is not limited to that particular arrangement. Likewise functions discussed in the context of being performed by a particular module or device may be performed by a different module or device, or combined, without departing from the scope of the claims.

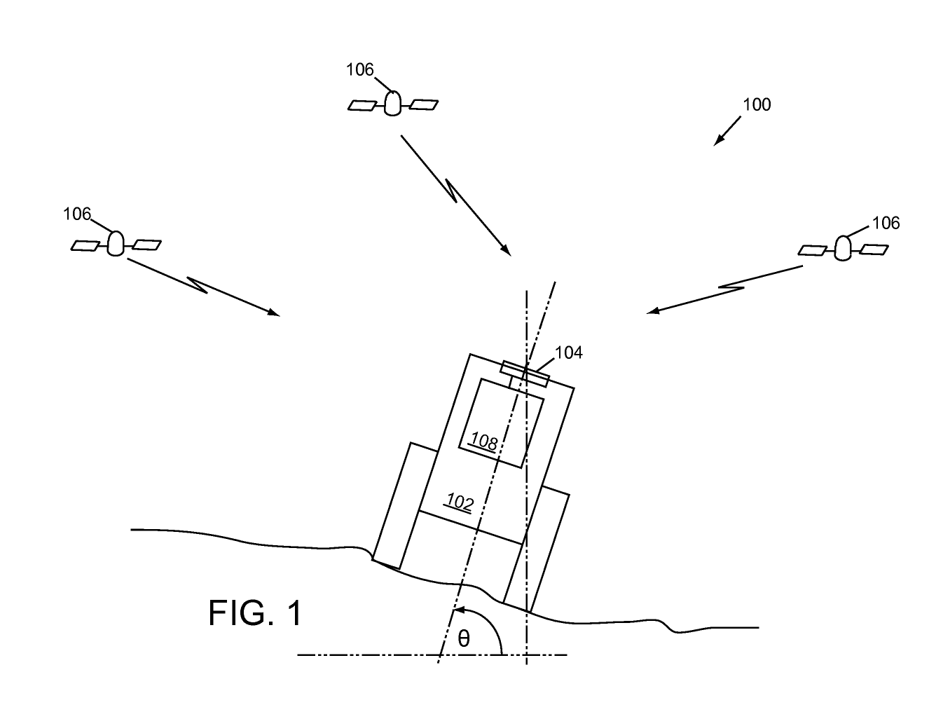

Referring now to the figures, the present invention will be described in detail. FIG. 1 depicts an example system 100 that includes a vehicle 102 equipped with an onboard satellite receiver unit (SRU) 104 configured to receive signals from one or more navigational satellites 106. An attitude determination module (ADM) 108 is coupled to the SRU 104 and configured to determine the attitude of the SRU 104, which is also the attitude of the platform on which it is mounted, in this case the vehicle 102. In an example embodiment, the ADM 108 can provide roll and pitch angles for the SRU 104 which can be used to determine the SRU104 and vehicle 102 location. In an exemplary embodiment, the SRU 104 can use various algorithms as known in the art to calculate a first geographical position based on received satellite navigational signals from several satellites. The SRU 104 first geographical position may be sufficiently accurate when the vehicle 102 is on level ground. However, on sloped terrain the geographical position provided by the SRU 104 can include errors induced by vehicle 102 attitude. The ADM 108 can determine roll and/or pitch angles, such as 8 shown in FIG. 1, for the SRU 104 that can be used to adjust the first geographical position to provide a more accurate geo-position for improved navigation by a vehicle guidance system.

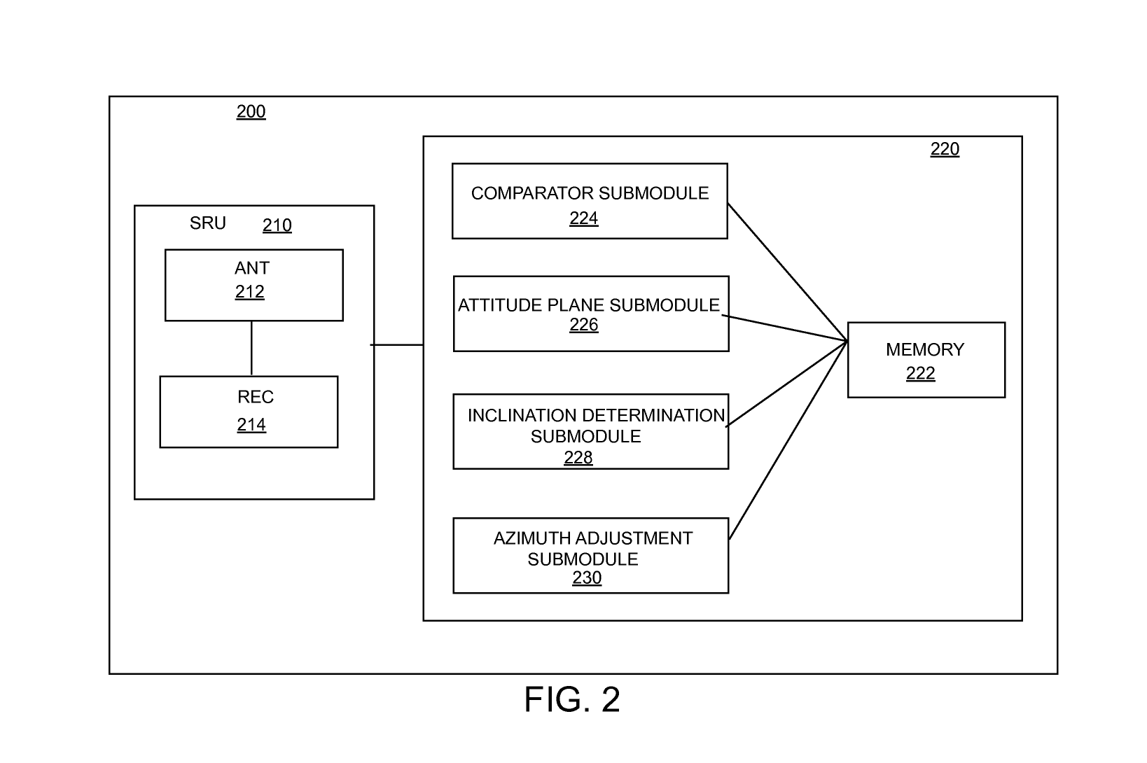

FIG. 2 shows an example system 200 for determining platform attitude. The system 200 includes an SRU 210 and an ADM 220. The SRU 210 can comprise a satellite antenna 212 for detecting satellite navigation signals, and a satellite receiver 214 for determining a geographical location using the detected signals. For example, the antenna 212 can be configured to detect signals from a plurality of navigational satellites, and be in the form of an active or passive antenna, by way of example, but not limitation, a passive ceramic patch antenna, an external active antenna, or an active or passive helix antenna.

In an example embodiment, the receiver 214 can use techniques known in the art, such as, but not limited to trilateration, Bancroft's method, or multi-dimensional Newton-Raphson calculations, to determine a geographical location or geo-position for the SRU 210. In an exemplary embodiment the receiver 214 can also determine the gain of a received signal, as well as the elevation and azimuth angles of the transmitting satellite.

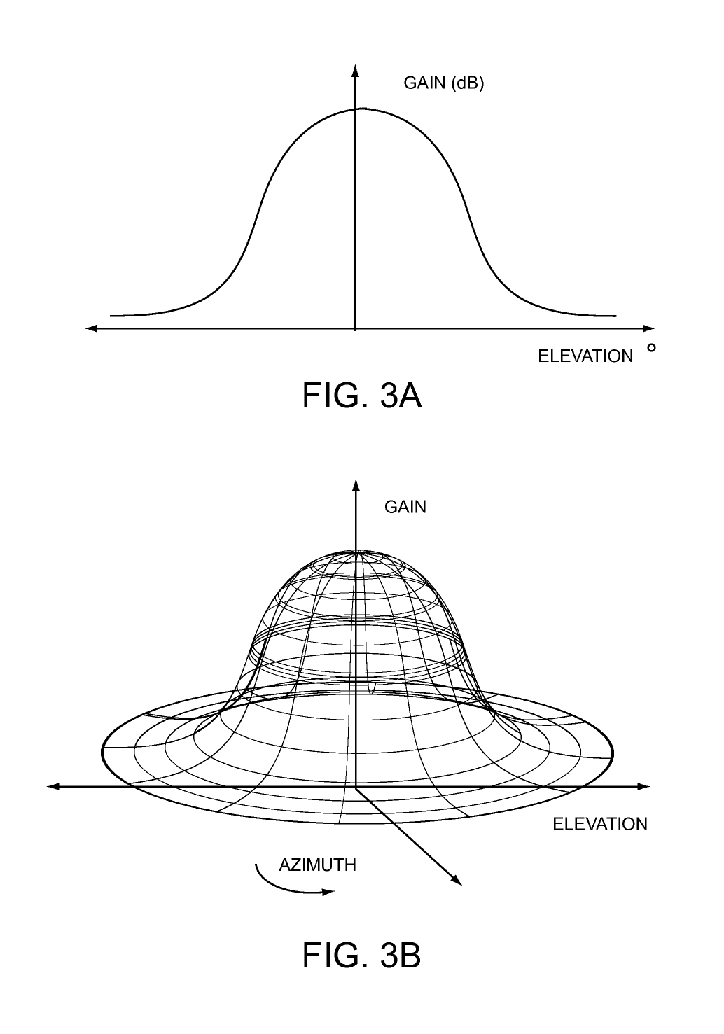

The ADM 220 can comprise the hardware, software, and/or firmware to implement the logic for coarse attitude determination. The example ADM 220 can include a memory 222, a comparator submodule 224, an attitude plane submodule 226, and an inclination submodule 228. The memory 222 can be configured to store antenna profile parameters associated with the satellite antenna 212. By way of example, but not limitation, the antenna 212 can have a gain profile as shown in the FIG. 3A plot of antenna gain versus satellite elevation. As shown in FIG. 3, antenna gain can be at its maximum when a satellite is directly overhead, and decreases with decreasing satellite elevation. In an example embodiment, the antenna gain pattern can be stored at the memory 222 in the form of a look up table of gain and elevation values, or as a mathematical function expressing gain in terms of elevation. In an example embodiment, antenna gain can be independent of azimuth as illustrated in FIG. 3B which depicts a three-dimensional depiction of the gain profile. For this type of gain pattern, it may not be necessary to include azimuth angle in the function or look up table stored at the memory 222. However, in a further example, an antenna may have a gain profile that varies with azimuth, in which case azimuth dependency can be stored at the memory 222. In an example system, the antenna gain profile stored at the memory 222 is one derived from actual testing the particular antenna 212, so that each system 200 can be tailored to the actual antenna 212 employed, rather than using a generic universal antenna gain pattern for all deployed satellite antennas. For example, an antenna can be rotated while tracking a particular satellite and the gain of received signals at various elevations and azimuths can be recorded.

The ADM 220 can further include a comparator submodule 224 configured to compare receiver-based values associated with received satellite signals with expected values, i.e. values based on the antenna gain pattern. For example, the comparator submodule 224 can be configured to compare a satellite elevation value calculated at the receiver 214 with an effective elevation value based on the antenna gain pattern stored at the memory 222. By way of example, but not limitation, the comparator submodule 224 can refer to a look-up table in the memory 222 to retrieve the satellite elevation angle that corresponds to the gain of the received signal as calculated by the receiver 214. As a further example, the comparator submodule 224 can be configured to compare an effective gain for the signal at a calculated satellite elevation to an expected gain at the calculated elevation based on the antenna gain pattern.

The attitude plane submodule can be configured to use the difference between the receiver calculated and expected values to generate an attitude plane representing the attitude of the SRU 210 with respect to a horizontal plane. In an example embodiment, the attitude plane submodule 226 uses a plurality of differences based on signals from a plurality of satellites at a variety of elevations to provide a “best-fit” attitude plane in a three dimensional coordinate system.

The inclination submodule 228 can be configured to determine the inclination of the attitude plane produced at the attitude plane submodule 226. For example, by determining the angles of an attitude plane with orthogonal axes of horizontal reference plane, pitch and roll angles can be determined for the SRU 210.

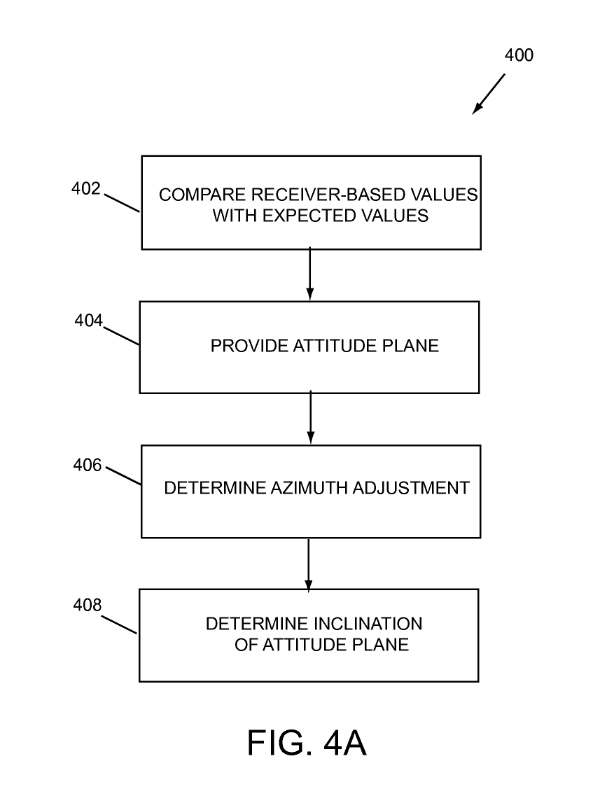

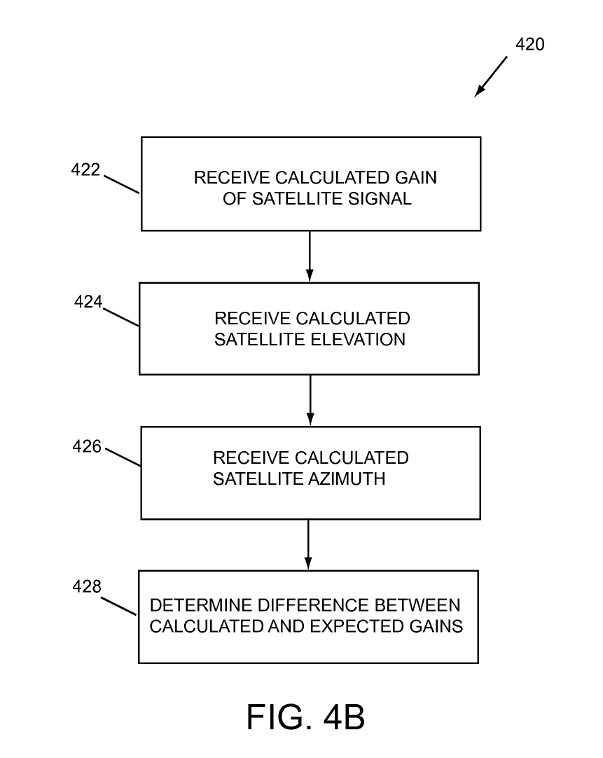

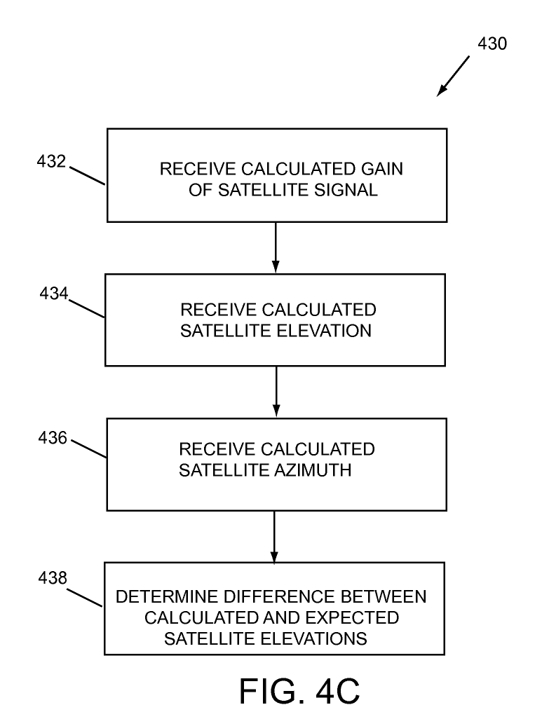

FIG. 4A shows an example method 400 for determining attitude. At block 402 receiver-based and antenna profile-based values associated with a signal can be compared. As an example, the comparator submodule 224 can receive SRU 210 calculated values and compare them with expected values based on the antenna gain pattern stored at the memory 222. FIG. 4B shows an example method 420 by which the receiver-calculated and expected values can be compared. At block 422 the gain of a received satellite signal can be received at the ADM 420. For example the gain calculated at the receiver 214 can be received at the comparator submodule 224. Similarly, at block 424, the calculated elevation of the satellite that transmitted the received signal can be received at the comparator submodule 224 from the receiver 214. At block 426 satellite azimuth calculated at the receiver 214 can be received at the ADM 220, for example at the comparator submodule 224, so that the ADM 220 receives several values associated with a particular SRU 210-received satellite signal, namely calculated gain, calculated satellite elevation, and calculated satellite azimuth.

At block 428, the difference between the gain calculated by the receiver 412 and the expected gain based on antenna profile can be determined. By way of example, but not limitation, the expected gain at the calculated satellite elevation, provided by the antenna profile stored at the memory 422, can be received at the comparator submodule 424, and the difference between it and the gain calculated by the receiver 214 can be determined. It is noted that this step can be repeated for a plurality of satellite signals received from a plurality of satellites at a variety of elevations and azimuths. In an example embodiment, difference values can be stored at the memory 222 in association with calculated azimuth and calculated elevation angles.

FIG. 4C shows an example method 430 for comparing receiver-based calculated and antenna profile-based expected values. At block 432, signal gain calculated at the receiver 412 can be received at the comparator submodule 224. At blocks 434, 436 calculated satellite elevation and azimuth respectively can be received at the comparator submodule 224. At block 438 the difference between the calculated satellite elevation, and the effective satellite elevation based on the antenna gain profile stored in the memory 222 and the calculated signal gain received from the receiver 214 can be determined. As with the example method 420, example method 430 can be repeated for signals from a plurality of satellites and elevations. In an example embodiment, signals from 6-8 satellites are used to generate a plurality of differences that can be used as data points for attitude plane generation.

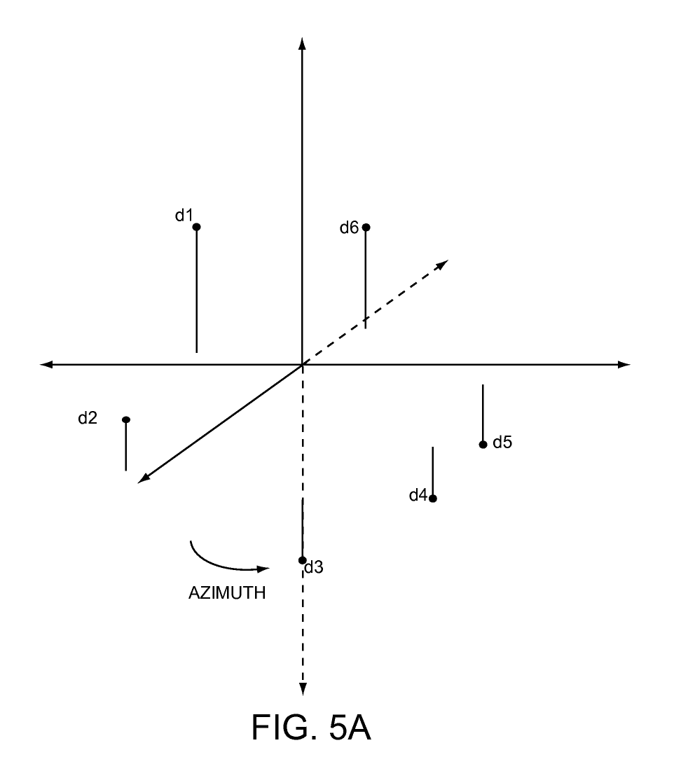

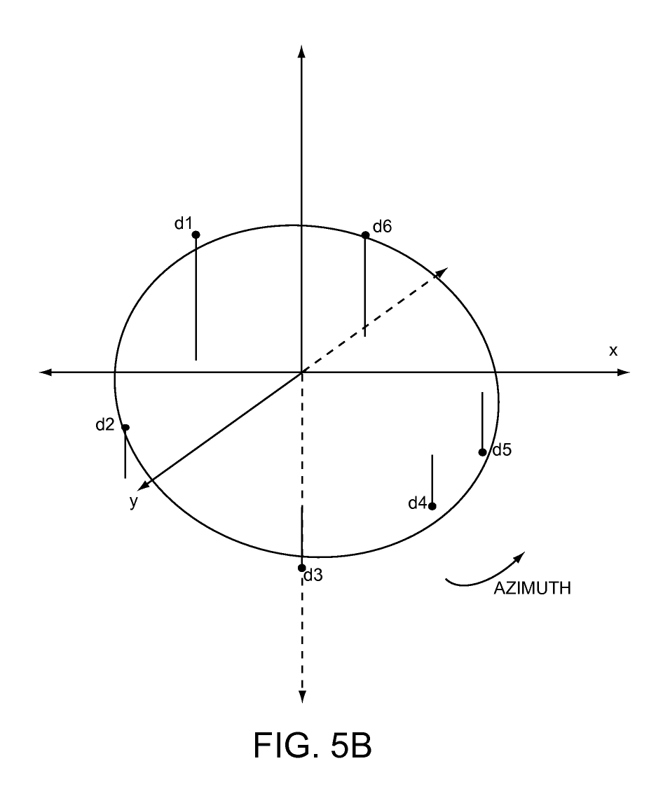

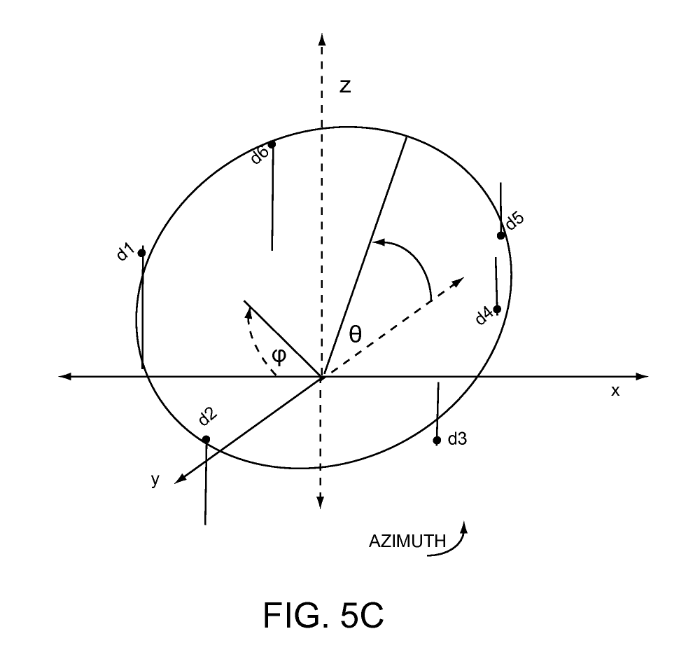

Referring back to FIG. 4A, the method 400 can continue with block 404, at which an attitude plane can be generated based on the differences determined in block 402. In an example embodiment, the difference values, stored at the memory 222 in association with particular satellite elevations and azimuths, can be used to define a plane in a three dimensional orthogonal coordinate system. For example, for a given azimuth difference value d can be plotted, as shown in FIG. 5A. In an example embodiment, a solution for an equation that orients a plane that satisfies the variables with the least deviation from the difference data points can be determined. For example, using techniques, an equation representing a “best-fit” circle defined by the data points can be determined, as shown in FIG. 5B. Noise will inherently be present in the calculated data and differences, so various filtering techniques, such as, but not limited to Kalman filtering can be employed to smooth results.

At block 406, azimuth adjustment for the attitude plane can be determined. As commonly practiced in the art, satellite azimuth is calculated by the receiver under the assumption that the receiver is facing or heading due north. Since the receiver 214 is mounted on the land vehicle 105 that can be travelling in a direction other than north, the attitude plane determined by the attitude plane submodule 226 may need to be rotated or adjusted in azimuth to more accurately represent SRU 200 and vehicle 102 attitude. SRU 200 heading can be provided in a variety of ways. For example, an electronic compass can be configured to provide heading to the ADM 220. In a further example embodiment, a direction vector can be determined for the receiver 214 motion. By way of example, but not limitation, the azimuth adjustment submodule 230 can be configured to determine a direction vector by tracking sequential geographical locations. For example, the ADM 220 can receive geo-positions calculated by the receiver 214 and track them over a predetermined time interval to determine receiver 214 heading. If the calculated receiver heading is other than due north, the azimuth adjustment submodule 230 can use the difference between the direction heading and due north to adjust the attitude plane in azimuth, for example by rotating it about the z-axis as shown in FIG. 5C.

At block 408, the inclination of the attitude plane, adjusted for azimuth if necessary, can be determined. By way of example, the azimuth adjustment submodule 230 can determine the inclination with respect to a horizontal reference plane. Referring to FIG. 5C, the angle cp with respect to x-axis can be determined to provide a pitch value, and the angle 8 with respect to y-axis can be determined to provide a roll pitch value. These angles can be determined by mathematical calculations.

It is noted that the blocks of method 400 can be practiced in a sequence other than that depicted in FIG. 4A. For example, azimuth adjustment can be performed prior to attitude plane determination; a desirable sequence when a satellite antenna has a gain profile that is azimuth dependent. In fact antennas that have gain patterns that drop at particular azimuths, may be considered undesirable from an overall gain perspective, but can be helpful in the attitude determination process. When the gain at one azimuth is noticeably different from the gain at a second azimuth, data points can be more accurately distinguished, improving the accuracy of the attitude plane determination process. When an antenna pattern has an azimuth dependency, errors can be induced when an attitude plane is generated independent of azimuth, then rotated to compensate for vehicle heading. Systems employing such an antenna can be configured to adjust values for azimuth prior to generating an attitude plane.

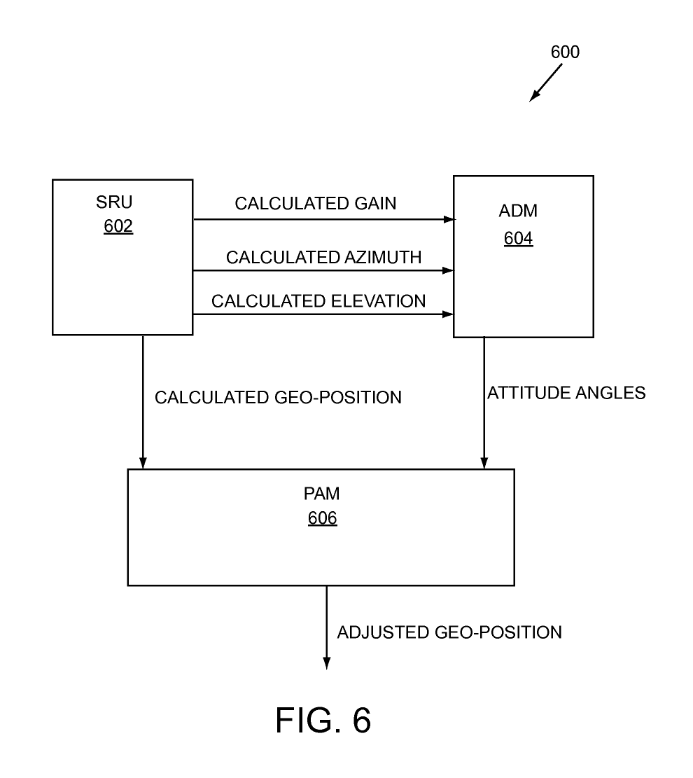

Thus an ADM can provide a coarse attitude determination for a receiver unit mounted on a moving vehicle. In an example embodiment, ADM-determined roll and pitch values can be used to improve geo-positioning accuracy in systems that lack onboard inertial sensors. FIG. 6 shows an example system 600 that includes an SRU 602 and an ADM 604 coupled to a position adjustment module (PAM) 606. The PAM 606 can be configured to use roll and pitch values determined at the ADM 604 to adjust a geographical position calculated at the SRU 602 to provide a more accurate revised geographical position. The revised geographical position can then be provided to an onboard guidance system to improve vehicle navigation. An ADM can also be deployed in systems that include onboard inertial sensors. In this environment, ADM output can be used to authenticate sensor results and geo-position calculations.

1. A system for attitude determination, comprising:
a satellite receiver unit (SRU) having a single SRU antenna and being configured for satellite signal reception; and
an attitude determination module (ADM) coupled to said SRU and configured to determine attitude of said SRU based on a received satellite signal and without inertial sensor input.

2. The system of claim 1, wherein said ADM is configured to determine attitude of said SRU using an antenna gain pattern associated with said SRU antenna.

3. The system of claim 1, wherein said ADM is configured to compare values calculated at said SRU with expected values based on an antenna gain pattern for said SRU antenna.

4. The system of claim 3, wherein said ADM is configured to compare an expected satellite elevation with a satellite elevation calculated at said SRU.

5. The system of claim 3, wherein said ADM is configured to compare an expected gain for a signal received at said SRU with a gain for said signal calculated at said SRU.

6. The system of claim 1, wherein said ADM is configured to generate an attitude plane based on differences between values calculated at said SRU and expected values based on an antenna pattern for said SRU.

7. The system of claim 6, wherein said ADM is configured to determine inclination of said attitude plane to determine said SRU attitude.

8. The system of claim 1, further comprising a position adjustment module configured to adjust a geo-position calculated at said SRU using pitch and roll values determined at said ADM.

9. An attitude determination module (ADM) connectable to a satellite signal receiver operating to generate receiver-calculated values associated with a received satellite signal, said ADM comprising:
an azimuth adjustment submodule configured to receive and adjust receiver-calculated said values to compensate for receiver heading;
a comparator submodule configured to determine difference between a receiver-calculated value associated with a received satellite signal and an expected value based on an antenna gain profile;
an attitude plane submodule for providing an attitude plane based on said differences;
and an inclination determination submodule configured to determine inclination of said attitude plane with a horizontal reference plane.

10. The ADM of claim 9, wherein said comparator submodule is configured to determine the difference between a satellite elevation calculated at said receiver and an expected satellite elevation based on said antenna gain profile.

11. The ADM of claim 9, wherein said comparator submodule is configured to determine the difference between an antenna gain calculated at said receiver and an expected gain based on said antenna profile.

12. The ADM of claim 9, wherein said attitude plane submodule is configured to use a plurality of said differences to generate said attitude plane.

13. The ADM of claim 9, wherein said comparator submodule is configured to determine said differences based on signals received from a plurality of satellites.

14. The ADM of claim 9, further comprising a memory for storing said antenna gain profile.

15. A method for determining platform attitude, comprising:
comparing receiver-based values associated with a received satellite signal with expected values;
using difference between said receiver-based and said expected values to determine an attitude plane; and
determining inclination of said attitude plane with a reference plane to provide said receiver attitude.

16. The method of claim 15, further comprising rotating said attitude plane for proper azimuth alignment.

17. The method of claim 15, wherein said expected value is based on an antenna gain profile.

18. The method of claim 15, wherein said comparing receiver-based value with expected value comprises finding the difference between a receiver-calculated satellite elevation and an expected satellite elevation.

19. The method of claim 15, wherein said comparing receiver-based value with expected value comprises finding the difference between a receiver-calculated gain and an expected gain.

20. The method of claim 15, wherein said comparing receiver-based values with expected values comprises comparing receiver-based and expected values associated with signals from a plurality of satellites.
